(19) United States
(12) Patent Application Publication
(10) Pub. No.: US 2007/0258099 A1
(43) Pub. Date: Nov. 8, 2007

(54) Self-aligning color optical print head

(76) Inventors: Andrew L. Van Brocklin, Corvallis, OR (US); Kuohua Wu, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/418,688

(22) Filed: May 5, 2006

(51) Int. Cl. G06K 15/02

(52) U.S. Cl. 358/1.2

(57) ABSTRACT

This invention relates to a self aligning optical printing system, comprising: an electromagnetic energy beam source capable of emitting a plurality of electromagnetic energy beams of differing wavelengths; a plurality of lenses located substantially adjacent to each other such that each of the plurality of electromagnetic energy beams interacts with one of the plurality of lenses to self align the plurality of electromagnetic energy beams with respect to each other; and a multi-wavelength media located adjacent to the plurality of lenses such that the plurality of self aligned electromagnetic energy beams interacts with the media.

### BACKGROUND OF THE INVENTION

1. Field of the Invention

This invention relates to a self aligning optical printing system, comprising: an electromagnetic energy beam source capable of emitting a plurality of electromagnetic energy beams of differing wavelengths; a plurality of lenses located substantially adjacent to each other such that each of the plurality of electromagnetic energy beams interacts with one of the plurality of lenses to self align the plurality of electromagnetic energy beams with respect to each other; and a multi-wavelength media located adjacent to the plurality of lenses such that the plurality of self aligned electromagnetic energy beams interacts with the media.

2. Description of the Related Art

Prior to the present invention, as set forth in general terms above and more specifically below, it is known, that optical disc drives have historically been used to optically read data from and optically write data to data regions of optical discs. More recently, optical disc drives have been used to optically write images to label regions of optical discs. For example, a type of optical disc is known in which a laser or other optical beam can be used to write to the label side of an optical disc.

It is also known for some multi-wavelength media to utilize an optical print head that employs up to three lasers with long focal lengths and essentially random positioning. The problems associated with these type of optical print heads are that the lasers require accurate positioning and more importantly, the writing system parameters must be constantly monitored/changed in order to adjust for the laser positioning.

It is further known for some multi-wavelength media to employ a hybrid lens long focal length or short focal length solution. The disadvantage of this type of optical print head is that undesirable thermal crosstalk can be created. Consequently, a more advantageous optical print head for use with multi-wavelength media, then, would be provided if such laser positioning and hybrid lens long focal length or short focal length solutions could be avoided.

It is apparent from the above that there exists a need in the art for an optical print head for use with multi-wavelength media that employs a self alignment of three lasers spots of different wavelengths through the use of lenses that are designed to be positioned above media. It is a purpose of this invention to fulfill this and other needs in the art in a manner more apparent to the skilled artisan once given the following disclosure.

### SUMMARY OF THE INVENTION

Generally speaking, an embodiment of this invention fulfills these needs by providing a self aligning optical printing system, comprising: an electromagnetic energy beam source capable of emitting a plurality of electromagnetic energy beams of differing wavelengths; a plurality of lenses located substantially adjacent to each other such that each of the plurality of electromagnetic energy beams interacts with one of the plurality of lenses to self align the plurality of electromagnetic energy beams with respect to each other; and a multi-wavelength media located adjacent to the plurality of lenses such that the plurality of self aligned electromagnetic energy beams interacts with the media.

In certain preferred embodiments, the optical beam source emits optical beams (electromagnetic energy beams)that have at least three differing wavelengths. Also, there are three lenses located substantially adjacent to each other such that each one of the electromagnetic energy beams interacts with only one of the three lenses. Finally, the self aligning optical printing system further includes a sensor/detector for controlling the distance between the plurality of lenses and the multi-wavelength media.

In another further preferred embodiment, an optical print head is utilized with multi-wavelength media that employs a self alignment of three lasers spots of different wavelengths through the use of lenses that are designed to be positioned above media.

The preferred self aligning optical printing system, according to various embodiments of the present invention, offers the following advantages: ease-of-use; optical beam self alignment; reduced thermal crosstalk; and improved printing quality. In fact, in many of the preferred embodiments, these factors of optical beam self alignment, reduced thermal crosstalk, and improved printing quality are optimized to an extent that is considerably higher than heretofore achieved in prior, known optical printing systems.

The above and other features of the present invention, which will become more apparent as the description proceeds, are best understood by considering the following detailed description in conjunction with the accompanying drawings, wherein like characters represent like parts throughout the several views and in which:

### BRIEF DESCRIPTION OF THE DRAWINGS

FIG. 1 is a schematic illustration of a self aligning color optical print head, according to one embodiment of the present invention;

FIG. 2 is a schematic illustration of the lens holding system for the self aligning color optical print head, according to another embodiment of the present invention;

FIG. 3 is a schematic illustration of the self aligned optical beams of the self aligning color optical print head, according to another embodiment of the present invention; and

FIG. 4 is a schematic illustration of the self aligned color optical print head having two optical mechanisms for accessing both sides of an optical disc without having to have a user remove the disc from the drive, flip it over, and reinsert the disc into the drive, according to an embodiment of the invention.

### DETAILED DESCRIPTION OF THE INVENTION

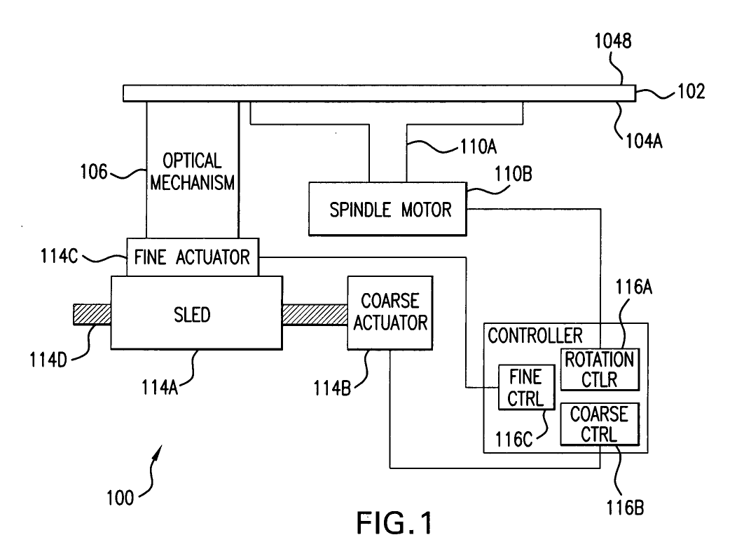

With reference first to FIG. 1, there is illustrated one preferred embodiment for use of the concepts of this invention. FIG. 1 shows an optical disc drive 100, according to an embodiment of the invention. The optical drive 100 is for reading from and/or writing to an optically writable multi-wavelength optical disc 102 which has a label side 104A opposite a data side 104B. More specifically, the optical drive 100 is for reading from and/or writing to an optically writable multi-wavelength label side 104A of the optical disc 102, and/or an optically writable data side 104B of the optical disc 102, which are collectively referred to as the sides 104 of the optical disc 102. It is to be understood that the term “multi-wavelength” refers to the ability of optical disc 102 to address multiple color forming elements optically written upon.

The optically writable data side 104B of the optical disc 102 includes a data region on which data may be optically written to and/or optically read by the optical drive 100. The data side 104B is thus the side of the optical disc 102 to which binary data readable by the optical drive 100 and understandable by a computing device is written, and can be written by the optical drive 100 itself. For instance, the data side 104B may be the data side of a compact disc (CD), a CD-readable (CD-R), which can be optically written to once, a CD-readable/writable (CD-RW), which can be optically written to multiple times, and so on. The data side 104B may further be the data side of a digital versatile disc (DVD), a DVD-readable (DVD-R), or a DVD that is readable and writable, such as a DVD-RW, a DVD-RAM, or a DVD+RW. The data side 104B may further be the data side of a high-capacity optical disc, such as a Blu-ray optical disc, and so on. Furthermore, there may be a data region on each side of the optical disc 102, such that the optical disc is double sided, and such that there is a label region on at least one of the sides of the disc.

The optically writable label side 104A of the optical disc 102 includes a label region on which a color image may be optically written thereto, to effectively label the optical disc 102. The label side 104A is thus the side of the optical disc 102 to which visible color markings can be optically written to realize a desired label image. It is noted in one embodiment that both the sides 104A and 104B of the optical disc 102 may have both label regions and data regions.

The optical drive 100 is depicted in FIG. 1 as including an optical mechanism 106. Different and specific embodiments of the optical mechanism 106 are described in detail later in the detailed description. In general, however, the optical mechanism 106 employs a plurality of objective lenses to direct generated, self aligned electromagnetic energy (optical) beams to the surface of the optical disc 102. As such, the optical mechanism 106 is advantageous because it may not need costly, complex, and precisely positioned lasers and other components. It is to be understood that a typical embodiment may have, but will not typically have a fine actuator 114C, but it would have a voice coil motor for focus (focus actuator) which is not shown here.

In particular, the optical mechanism 106 is applicable for using the optical mechanism 106 to optically write to the label side 104A of the optical disc 102, because less precision is needed to optically write to and/or read from the label side 104A, as opposed to optically writing to and/or reading from the data side 104B. In such an embodiment of the invention, the optical mechanism 106 may be referred to as an optical color print head, because it is used to optically write marks to the label side 104A, to achieve a desired colored image on the label side 104A of the optical disc 102. However, in other embodiments, the optical mechanism 106 may also be able to be used to optically write to and/or read from the data side 104B, too.

The optical drive 100 is also depicted in FIG. 1 as including a spindle 110A and a spindle motor 110B, which are collectively referred to as the first motor mechanism 110. The spindle motor 110B rotates the spindle 110A, such that the optical disc 102 correspondingly rotates. The first motor mechanism 110 may include other components besides those depicted in FIG. 1. For instance, the first motor mechanism 110 may include a rotary encoder or another type of encoder to provide for control of the spindle motor 110B and the spindle 110A.

The optical drive 100 is further depicted in FIG. 1 as including a sled 114A, a coarse actuator 114B, a fine actuator 114C, and a rail 114D, which are collectively referred to as the second motor mechanism 114. The second motor mechanism 114 moves the optical mechanism 106 to radial locations relative to a surface of the optical disc 102. The coarse actuator 114B is or includes a motor that causes the sled 114A, and hence the fine actuator 114C and the optical mechanism 106 situated on the sled 114A, to move radially relative to the optical disc 102 on the rail 114D. The coarse actuator 114B thus provides for coarse or large radial movements of the fine actuator 114C and the optical mechanism 106.

By comparison, the fine actuator 114C also is or includes a motor, and causes the optical mechanism 106 to move radially relative to the optical disc 102 on the sled 114A. The fine actuator 114C thus provides for fine or small movements of the optical mechanism 106. The second motor mechanism 114 may include other components besides those depicted in FIG. 1. For instance, the second motor mechanism 114 may include a linear encoder or another type of encoder to provide for control of the coarse actuator 114B and the sled 114A. Note that it is possible to use a single motor for both actuations, under the condition that it has enough accuracy to provide acceptable print quality to the human eye. This single motor may or may not use an encoder strip to provide feedback to enhance accuracy of positioning and hence print quality. Furthermore, either or both of the motor mechanisms 110 and 114 may be considered as the movement mechanism of the optical drive 100.

It is noted that the utilization of a fine actuator 114C and a coarse actuator 114B, as part of the second motor mechanism 114, is representative of one, but not all, embodiments of the invention. That is, to radially move the optical mechanism 106 in relation to the optical disc 102, the embodiment of FIG. 1 uses both a fine actuator 114C and a coarse actuator 114B. However, in other embodiments, other types of a second motor mechanism 114C can be used to radially move the optical mechanism 106 in relation to the optical disc 102, which do not require both a fine actuator 114C and a coarse actuator 114B. For instance, a single actuator or other type of motor may alternatively be used to radially move and position the optical mechanism 106 in relation to the optical disc 102. One such alternative embodiment is described later, at the end of the detailed description.

The optical drive 100 is additionally depicted in FIG. 1 as including a controller 116. The controller 116 can, in one embodiment, include at least a rotation controller 116A, a coarse controller 116B, and a fine controller 116C. The mechanisms 116 may each be implemented in software, hardware, or a combination of software and hardware. The rotation controller 116A controls movement of the spindle motor 110B, and thus controls rotation of the optical disc 102 on the spindle 110A, such as the angular velocity of the rotation of the optical disc 102. The coarse controller 116B controls the coarse actuator 114B, and thus movement of the sled 114A on the rail 114D. The fine controller 116C controls the fine actuator 114C, and thus movement of the beam source 106A on the sled 114A.

The controller 116 may further include other components besides those depicted in FIG. 1. For instance, the controller 116 can be responsible for turning on and off, and focusing, the optical beams. In addition, as can be appreciated by those of ordinary skill within the art, the components depicted in the optical drive 100 are representative of one embodiment of the invention, and do not limit all embodiments of the invention.

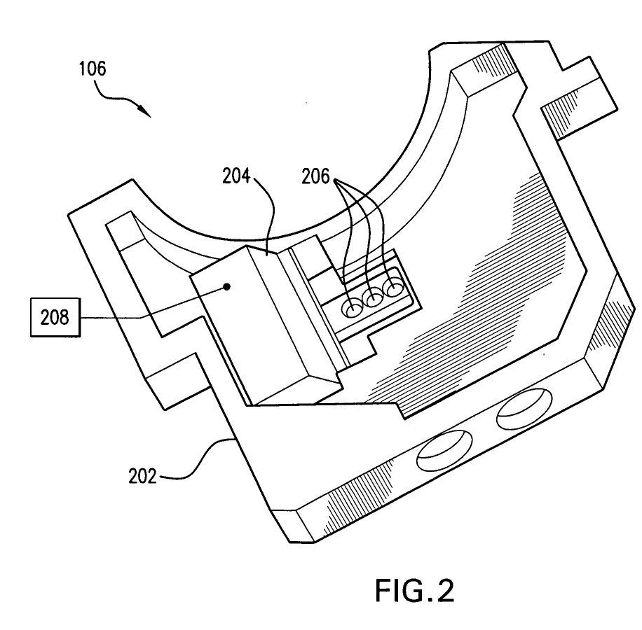

FIG. 2 shows the optical mechanism 106 of the optical disc drive 100 in detail, according to an embodiment of the invention. The optical mechanism 106 includes, in part, optical print head (OPH) 202, voice coil motor 204, a plurality of objective lenses 206, and voice coil motor controller 208. Optical print head 202, preferably, is constructed of any suitable, durable material that is capable of retaining the plurality of objective lenses 206. Voice coil motor 204, preferably, is any suitable motor that is capable of varying the distance between the plurality of objective lenses 206 and optical disk 102 (FIG. 1). This allows for a higher numerical aperture than that of a fixed focus system, and consequently if desired, a very high dots per inch print resolution. The plurality of objective lenses 206, preferably, are any suitable lenses that when the incident light behind the objective lenses hits the objective lenses normal to the plane of optical disk 102, the location of the focus of the light under the objective lenses will always be almost exactly under the vertex of the lens. In this manner, a self aligning property will result such that the three wavelengths of light emanating from the three objective lenses will always form spots on optical disk 102 in the same spatial relationship. It is to be understood that all three objective lenses 206 are designed to have the same focal length at the wavelengths that they are designed for. Preferably, the three surfaces of objective lenses 206 will be molded at the same time, from one piece of polymeric material, in a mold with the proper cavities for two aspheric optical quality surfaces each for the three aspherical lenses 206. It is to be further understood that objective lenses 206 are not typically hybrid lenses and do not need to be. However, they should have a standard, even asphere-type surface contour on at least one of the two surfaces and may be molded of soft glass or low birefringence polymeric materials such as Fuji COC. Finally, voice coil motor controller is, preferably, used to control the motion of voice coil motor 204.

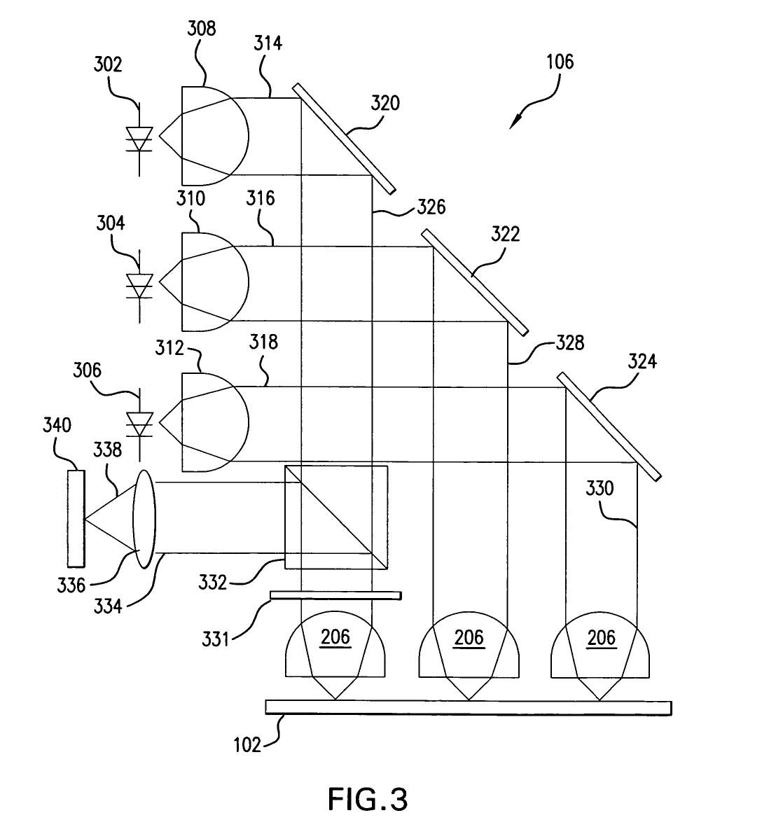

With respect to FIG. 3, optical mechanism 106 is further described. Optical mechanism 106 further includes, in part, optical beam generating mechanisms 302, 304, 306, objective lenses 308, 310, 312, optical beams 314, 316, 318, mirrors 320, 322, 324, optical beams 326, 328, 330, objective lenses 206, conventional quarter wave plate 331, conventional polarizing beam splitter 332, optical beam 334, lens 336, optical beam 338, and conventional sensor 340.

Optical beam generating mechanisms 302, 304, 306, preferably, include conventional laser diodes that are capable of emitting optical beams of differing wavelengths. Preferably, these wavelengths are 780 nm, 980 nm, and 1.3 um. One example of these diodes is the Sharp Corporation Japan's GH07P28 series of laser diodes. The plurality of optical beams 314, 316, 318 are conventionally collimated and transmitted through lenses 308, 310, 312 and impinged upon conventional mirrors 320, 322, and 324. Optical beams 326, 328, 330 are then directed towards the back of objective lenses 206 by mirrors 320, 322, and 324. It is to be understood that the working distance of the assembly of lenses 206 should be such that all the beams come to the desired focus at a single chosen distance between the lens assembly 206 and the media. This is so that the voice coil motor or other positioner can select one distance such that all the beams come to the desired focus. Also, it may be desirable that one or more lenses have an added, built-in offset from best focus to allow for differences in media thickness and media parameters for certain media. It is to be further understood that mirrors 320, 322, and 324 should be located above lenses 206 in order that optical mechanism 106 can be folded for minimum height. As discussed above, when the incident light behind the objective lenses hits the objective lenses normal to the plane of optical disk 102 (FIG. 1), the location of the focus of the light under the objective lenses will always be approximately under the vertex of the lens. In this manner, a self aligning property will result such that the three wavelengths of light emanating from the three objective lenses will always form spots on optical disk 102 in the same spatial relationship. It is to be further understood that the distance between each of the optical beams 326, 328, and 330 should be less than 100 microns and, preferably, between 25-50 microns.

As shown in FIG. 3, a conventional quarter wave plate 331, a conventional polarizing beam splitter 332, a conventional lens 336 and conventional sensor 340 are located in series adjacent to one of the objective lenses 206. This feedback mechanism allows for the sensor 340 to generate a signal for controlling the height of voice coil motor 204 (FIG. 2) and objective lenses 206. In this manner, optical mechanism 106 operates like a conventional voice coil motor controlled objective with two “sidecar” lenses that are focused using the focus servo of the first one. It is to be understood that since the thermal capacity of the body of the optical print head 202 (FIG. 2) is typically limited, it may be desirable to use three fibers or three collimated optical beams 314, 316, 318 to bring the laser light to the movable part of the optical print head 202. In this case, the strategy of three separate objective lenses 206 on the voice coil motor 204 still applies.

The optical mechanism 106 of various embodiments of the invention that have been described is at least for optically writing to the label side 104A of the optical disc 102. In one embodiment, the optical mechanism 106 may be able to be also employed to optically write to and/or optically read from the data side 104B of the optical disc 102. In such an embodiment, the optical disc 102 would have to be removed from the optical disc drive 100, flipped or turned over, and reinserted into the optical disc drive 100 for the optical mechanism 106 to access the label side 104A after the data side 104B of the optical disc 102 has been accessed, and vice-versa. This can be inconvenient for the user, however. In such situations, and in the embodiment where the optical mechanism 106 cannot be employed to optically write to and/or optically read from the data side 104B of the optical disc 102, the optical disc drive 100 may be modified to include two optical mechanisms, including the optical mechanism 106.

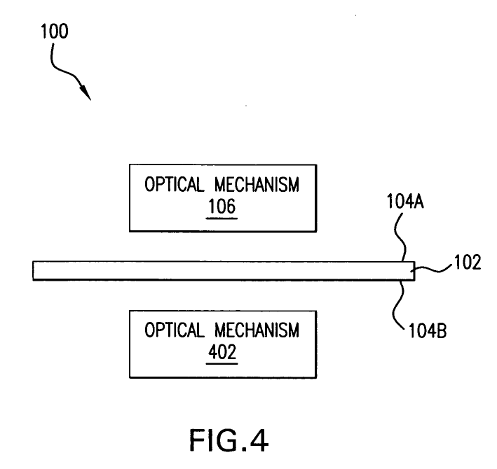

FIG. 4 shows the optical disc drive 100, according to such an embodiment of the invention. In particular, the optical disc drive 100 includes the optical mechanism 106 that has been described, as well as another optical mechanism 402 situated or disposed opposite to the optical mechanism 106. The other components of the optical disc drive 100 that are depicted in FIG. 1, such as various motor mechanisms and controllers, are not shown in FIG. 4 for illustrative convenience. Furthermore, the optical disc drive 100 of FIG. 4 may have additional components besides those depicted in FIG. 4, such as one or more motor mechanisms for the optical mechanism 402. The optical mechanism 106 is incident to the label side 104A of the optical disc 102 that has been inserted into the optical disc drive 100, whereas the optical mechanism 402 is incident to the data side 104B of the optical disc 102 that has been inserted into the optical disc drive 100.

As a result, access to both the label side 104A and the data side 104B of the optical disc 102 can be achieved by the optical disc drive 100, without having to have the user remove the disc 102 from the drive 100, flip it over, and reinsert the disc 102 into the drive 100 for the drive 100 to access the label side 104A after having accessed the data side 104B, and vice-versa. The optical mechanism 106 can be in accordance with the embodiments of the invention that have been described. By comparison, the optical mechanism 402 in one embodiment can be a conventional optical pickup unit (OPU). In another embodiment, however, the optical mechanism and 402 may be another instance of the optical mechanism 106 that has been described.

The present invention can be embodied in any computer-readable medium for use by or in connection with an instruction-execution system, apparatus or device such as a computer/processor based system, processor-containing system or other system that can fetch the instructions from the instruction-execution system, apparatus or device, and execute the instructions contained therein. In the context of this disclosure, a “computer-readable medium” can be any means that can store, communicate, propagate or transport a program for use by or in connection with the instruction-execution system, apparatus or device. The computer-readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc. It is to be understood that the computer-readable medium could even be paper or another suitable medium upon which the program is printed, as the program can be electronically captured, via, for instance, optical scanning of the paper or other medium, then compiled, interpreted or otherwise processed in a single manner, if necessary, and then stored in a computer memory.

Those skilled in the art will understand that various embodiment of the present invention can be implemented in hardware, software, firmware or combinations thereof. Separate embodiments of the present invention can be implemented using a combination of hardware and software or firmware that is stored in memory and executed by a suitable instruction-execution system. If implemented solely in hardware, as in an alternative embodiment, the present invention can be separately implemented with any or a combination of technologies which are well known in the art (for example, discrete-logic circuits, application-specific integrated circuits (ASICs), programmable-gate arrays (PGAs), field-programmable gate arrays (FPGAs), and/or other later developed technologies. In preferred embodiments, the present invention can be implemented in a combination of software and data executed and stored under the control of a computing device.

It will be well understood by one having ordinary skill in the art, after having become familiar with the teachings of the present invention, that software applications may be written in a number of programming languages now known or later developed.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A self aligning optical printing system, comprising:
an electromagnetic energy beam source capable of emitting a plurality of electromagnetic energy beams of differing wavelengths;
a plurality of lenses located substantially adjacent to each other such that each of the plurality of electromagnetic energy beams interacts with one of the plurality of lenses to self align the plurality of electromagnetic energy beams with respect to each other; and
a multi-wavelength media located adjacent to the plurality of lenses such that the plurality of self aligned electromagnetic energy beams interacts with the media.

2. The printing system, as in claim 1, wherein the optical beam source is further comprised of:
a plurality of laser diodes that are capable of emitting the plurality of electromagnetic energy beams of differing wavelengths.

3. The printing system, as in claim 1, wherein the differing wavelengths are 780 nm, 980 nm, and 1.3 um.

4. The printing system, as in claim 1, wherein the plurality of lenses is further comprised of: objective lenses.

5. The printing system, as in claim 4, wherein the objective lenses are further comprised of:
standard, even asphere-type surface contour lenses.

6. The printing system, as in claim 1, wherein the printing system is further comprised of:
a motor means operatively connected to the plurality of lenses for varying a distance between the plurality of lenses and the multi-wavelength media.

7. The printing system, as in claim 6, wherein the motor means is further comprised of:
a voice coil motor; and
a voice coil motor controller operatively connected to the voice coil motor.

8. The printing system, as in claim 1, wherein the printing system is further comprised of:
a voice coil motor control feedback mechanism.

9. The printing system, as in claim 8, wherein the feedback mechanism is further comprised of:
a quarter wave plate located substantially adjacent to one of the plurality of lenses;
a polarizing beam splitter located substantially adjacent to the quarter wave plate;
a feedback lens located substantially adjacent to the polarizing beam splitter; and
a sensor located substantially adjacent to the feedback lens.

10. A method of operating a self aligning electromagnetic energy print head, comprising:
creating a plurality of electromagnetic energy beams having differing wavelengths;
directing the plurality of electromagnetic energy beams towards a first plurality of lenses; and
focusing the plurality of electromagnetic energy beams upon a multi-wavelength media wherein the plurality of electromagnetic energy beams are self aligned such that the plurality of electromagnetic energy beams will always form marks on the multi-wavelength media in a same spatial relationship.

11. The method, as in claim 10, wherein the creating step is further comprised of:
generating the plurality of electromagnetic energy beam to create electromagnetic energy beams that have wavelengths of 780 nm, 980 nm, and 1.3 um.

12. The method, as in claim 10, wherein the directing step is further comprised of:
collimating the plurality of electromagnetic energy beams;
transmitting the plurality of electromagnetic energy beams through a second plurality of lenses; and
impinging the plurality of electromagnetic energy beams upon a plurality of mirrors.

13. The method, as in claim 10, wherein the method is further comprised of:
controlling the focusing of the plurality of electromagnetic energy beams.

14. The method, as in claim 13, wherein the controlling step is further comprised of:
operating a motor means to control a distance between the first plurality of lenses and the multi-wavelength media.

15. The method, as in claim 14, wherein the operating step is further comprised of:
providing feedback to the motor means in order to control the distance between the first plurality of lenses and the multi-wavelength media.

16. A program storage medium readable by a computer, tangibly embodying a program of instructions executable by the computer to perform method steps for a method of operating a self aligning optical print head, comprising:
creating a plurality of electromagnetic energy beams having differing wavelengths;
directing the plurality of electromagnetic energy beams towards a first plurality of lenses; and
focusing the plurality of electromagnetic energy beams upon a multi-wavelength media wherein the plurality of electromagnetic energy beams are self aligned such that the plurality of electromagnetic energy beams will always form marks on the multi-wavelength media in a same spatial relationship.

17. The method, as in claim 16, wherein the creating step is further comprised of:
generating the plurality of optical beam to create electromagnetic energy beams that have wavelengths of 780 nm, 980 nm, and 1.3 um.

18. The method, as in claim 16, wherein the directing step is further comprised of:
collimating the plurality of electromagnetic energy beams;
transmitting the plurality of electromagnetic energy beams through a second plurality of lenses; and
impinging the plurality of electromagnetic energy beams upon a plurality of mirrors.

19. The method, as in claim 16, wherein the method is further comprised of:
controlling the focusing of the plurality of electromagnetic energy beams.

20. The method, as in claim 19, wherein the controlling step is further comprised of:
operating a motor means to control a distance between the first plurality of lenses and the multi-wavelength media.

21. The method, as in claim 20, wherein the operating step is further comprised of:
providing feedback to the motor means in order to control the distance between the first plurality of lenses and the multi-wavelength media.
